(19) United States
(12) Patent Application Publication
(10) Pub. No.: US 2025/0332891 A1
(43) Pub. Date: Oct. 30, 2025

(54) Vehicular Windows and Windshield Adjustable Tinting System and Method of Use

(71) Applicant: Tajinder Sekhon, Modesto, CA (US)

(72) Inventor: Tajinder Sekhon, Modesto, CA (US)

(21) Appl. No.: 19/087,878

(22) Filed: Mar. 24, 2025

Related U.S. Application Data
(60) Provisional application No. 63/638,632, filed on Apr. 25, 2024.

(51) Int. Cl. B60J 3/04; B60J 1/02; B60K 35/10; B60K 35/40; G02F 1/153

(52) U.S. Cl. CPC B60J 3/04; B60K 35/10; B60K 35/415; G02F 1/153; B60J 1/02; B60K 2360/126

(57) ABSTRACT

A window tinting system for vehicles is disclosed. The system includes a tinted glass with adjustable tint levels, controlled automatically or manually. The automatic adjustment is facilitated by a light sensor detecting sunlight intensity and transmitting data to a tint control module, which adjusts the tint level for optimal protection. A control knob disposed on the vehicle's dashboard is linked to the tint control module through control circuitry and can be turned to manually adjust tint. Additionally, a mobile application enables remote control of the tint level. The tinted glass features an outer photochromic layer that darkens in response to UV light and an inner electrochromic layer controlled by the tint control module.

### CROSS-REFERENCE TO RELATED APPLICATION

The present application claims priority to, and the benefit of, U.S. Provisional Application No. 63/638,632, which was filed on Apr. 25, 2024 and is incorporated herein by reference in its entirety.

### FIELD OF THE INVENTION

The present invention generally relates to the field of vehicle window tinting solutions. More specifically, the present invention relates to a novel window tinting system that provides adjustable tint levels for car or vehicle windows and windshields. The system comprises tinted glass, enabling for automatic and manual tint adjustment. A control element, such as a knob, facilitates manual adjustments, while a light sensor enables automatic tint changes based on sunlight intensity. The system also includes a mobile application for remote control, ensuring precise and convenient tint management. Accordingly, the present disclosure makes specific reference thereto. Nonetheless, it is to be appreciated that aspects of the present invention are also equally applicable to other like applications, devices, and methods of manufacture.

### BACKGROUND

By way of background, sunlight entering through vehicle windows poses several challenges and inconveniences for drivers and passengers. One major issue is the reduced visibility caused by glare, which can significantly increase the risk of accidents. Additionally, prolonged exposure to ultraviolet (UV) light through untinted windows can lead to long-term damage to both eyes and skin, as well as vehicle interiors, necessitating the need for effective UV protection.

Individuals often use traditional glass films and other similar sunlight blocking devices in vehicles for tinting windows and blocking sunlight. However, these options are often expensive and require regular maintenance to remain effective. For example, glass films are prone to tearing and other forms of damage, requiring frequent replacements. Further, the process of applying and removing the sun blocking films can be cumbersome and time-consuming. Improper application can result in scratches and other types of damage to the windows. Current sunlight blocking devices are not adapted to accommodate different shades and intensity of sunlight and are static in blocking the sunlight. Individuals desire a more reliable, durable, and user-friendly window tinting system that provides consistent UV protection and glare reduction.

Therefore, there exists a long-felt need in the art for a window tinting system that provides an adjustable tint level for car or vehicle windows and windshields. There is also a long-felt need in the art for a novel tinting solution that eliminates the expense, maintenance issues, and application difficulties associated with traditional glass films. Additionally, there is a long-felt need in the art for an improved tinting system that can be easily controlled manually or automatically. Moreover, there is a long-felt need in the art for a window tinting system that can be seamlessly integrated into new vehicles as well as being available as an aftermarket product for existing automobile or vehicles. Further, there is a long-felt need in the art for a tinting system that includes advanced features such as remote control via a mobile application and automatic adjustment based on sunlight intensity. Furthermore, there is a long-felt need in the art for a dual-layered glass design that combines photochromic and electrochromic layers for enhanced performance. Finally, there is a long-felt need in the art for a comprehensive window tinting solution that provides durability, ease of use, and superior UV protection.

The subject matter disclosed and claimed herein, in one embodiment thereof, comprises a vehicular window and windshield tinting system. The system includes tinted car or vehicle windows and windshield, each window and windshield having an adjustable tint level, a control element is disposed inside the vehicle for adjusting the tint level of the windows and windshield, control circuitry is coupled to the control element and the windows and windshield, the control circuitry is adapted to transmit control signals from the control element to the tinted windows and windshield, and a tint control module is adapted to control and adjust the tint level of the window and windshield in response to the control signals. A light sensor detects the intensity of sunlight and transmits data to the tint control module, wherein the tint control module automatically adjusts the tint level based on the data from the light sensor.

In this manner, the window tinting system of the present invention accomplishes all of the foregoing objectives and provides users with a novel system for enhancing vehicle comfort, privacy, and UV protection through adjustable tint levels for car or vehicle windows and windshields. The system features a tinted glass that can be seamlessly integrated into new vehicles during the design and build process or added to existing automobile or vehicles as an aftermarket product. The control element, in the form of a knob, enables for precise manual adjustment of the tint level, while the integrated light sensor enables automatic adjustment based on sunlight intensity. Additionally, the system includes a mobile application for remote control of the tint level, offering convenience and additional functionality.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a window tinting system for a vehicle. The system includes a tinted glass configured to be used as a car or vehicle window and/or windshield, the tinted glass having an adjustable tint level, a control element disposed inside the vehicle for adjusting the tint level of the tinted glass, control circuitry is coupled to the control element and the tinted glass, the control circuitry is adapted to transmit control signals from the control element to the tinted glass, and a tint control module is adapted to control and adjust the tint level of the tinted glass in response to the control signals. A light sensor detects the intensity of sunlight and transmits data to the tint control module, wherein the tint control module automatically adjusts the tint level based on the data from the light sensor.

In yet another embodiment, a tinted glass for a vehicle window or windshield is disclosed. The tinted glass includes an outer layer configured to function as a photochromic layer, automatically darkening in response to UV light, an inner layer configured to function as an electrochromic layer, the tint level of which is adjustable via control signals, and wherein the tinted glass is adapted to adjust the tint level autonomously or automatically in response to sunlight and manually through user input via control signals.

In another embodiment, a manual window tinting system for a vehicle is disclosed. The system comprises a tinted glass configured to be used as a car or vehicle window and/or windshield, the tinted glass having an adjustable tint level, a control element disposed inside the vehicle for manually adjusting the tint level of the tinted glass, control circuitry coupled to the control element and the tinted glass, the control circuitry adapted to transmit control signals from the control element to the tinted glass, and a tint control module adapted to receive the control signals and adjust the tint level of the tinted glass based on user inputs from the control element.

In another aspect, a method for adjusting the tint level of vehicle windows and windshields is described. The method includes the steps of installing a tinted glass configured to be used as a car or vehicle window and/or windshield, the tinted glass having an adjustable tint level, detecting the intensity of sunlight using a light sensor, transmitting data from the light sensor to a tint control module, automatically adjusting the tint level of the tinted glass based on the data received from the light sensor to provide optimal UV protection and glare reduction, and manually adjusting the tint level of the tinted glass using a control element disposed inside the vehicle, wherein the control element is coupled to the tint control module via control circuitry, and the tint control module adjusts the tint level in response to control signals from the control element.

In yet another aspect, the control element is a control knob disposed on the dashboard of the vehicle, the control knob being turnable to select the tint level of the tinted glass.

In still another embodiment, the system includes a mobile application installed on a handheld electronic computing device, the mobile application being adapted to transmit wireless instruction signals to the tint control module for adjusting the tint level of the tinted glass remotely.

In another aspect, the tinted glass includes an outer photochromic layer that darkens automatically in response to UV light and an inner electrochromic layer that adjusts the tint level based on control signals received from the tint control module.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of advanced window tinting system of the present invention in accordance with the disclosed structure;

FIG. 2 illustrates a flow chart depicting a process of automatic tint adjustment of the windows and windshield using the windows tint adjustment system of the present invention in accordance with the disclosed structure;

FIG. 3 illustrates a perspective view showing the control element disposed inside the vehicle for controlling tint of windows and windshield in accordance with the disclosed structure;

FIG. 4 illustrates a perspective view of the one embodiment of the dual tint glass used for making windows and windshield in accordance with the disclosed structure; and

FIG. 5 illustrates a perspective view showing a user using a mobile phone for remotely controlling tint of the windows and windshield in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a window tinting system that provides an adjustable tint level for car or vehicle windows and windshields. There is also a long-felt need in the art for a novel tinting solution that eliminates the expense, maintenance issues, and application difficulties associated with traditional glass films. Additionally, there is a long-felt need in the art for an improved tinting system that can be easily controlled manually or automatically. Moreover, there is a long-felt need in the art for a window tinting system that can be seamlessly integrated into new vehicles as well as being available as an aftermarket product for existing automobile or vehicles. Further, there is a long-felt need in the art for a tinting system that includes advanced features such as remote control via a mobile application and automatic adjustment based on sunlight intensity. Furthermore, there is a long-felt need in the art for a dual-layered glass design that combines photochromic and electrochromic layers for enhanced performance. Finally, there is a long-felt need in the art for a comprehensive window tinting solution that provides durability, ease of use, and superior UV protection.

The present invention, in one exemplary embodiment, is a method for adjusting the tint level of vehicle windows and windshields. The method includes the steps of installing a tinted glass configured to be used as a car or vehicle window and/or windshield, the tinted glass having an adjustable tint level, detecting the intensity of sunlight using a light sensor, transmitting data from the light sensor to a tint control module, automatically adjusting the tint level of the tinted glass based on the data received from the light sensor to provide optimal UV protection and glare reduction, and manually adjusting the tint level of the tinted glass using a control element disposed inside the vehicle, wherein the control element is coupled to the tint control module via control circuitry, and the tint control module adjusts the tint level in response to control signals from the control element.

Reference will now be made in detail to the present preferred embodiments of the invention, examples of which are illustrated in the accompanying drawings. Wherever possible, the same reference numerals are used in the drawings and the description to refer to the same or like parts.

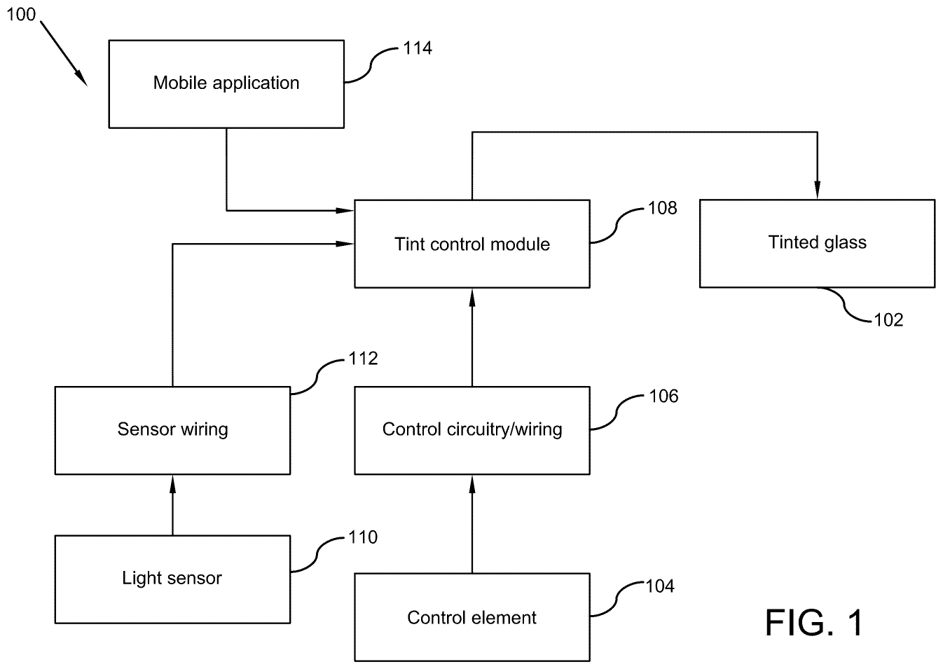

Referring initially to the drawings, FIG. 1 illustrates a schematic view of advanced window tinting system of the present invention in accordance with the disclosed structure. The window tinting system 100 of the present invention is designed to enhance vehicle comfort, privacy, and UV protection by adjusting the tint level of their car or vehicle windows and windshields. More specifically, the window tinting system 100 includes a tinted glass 102 that is adapted to be used as a car or vehicle window and/or windshield. The tinted glass 102 is configured to have an adjusted tint level wherein the tint level can be adjusted autonomously, automatically, or manually by a user. The tinted windows and windshields are preferably integrated into a vehicle during the design and build process. In some embodiments, the tinted windows and windshields can be added to an existing automobile or vehicle as an aftermarket product.

A control element 104 is disposed inside the vehicle such as on dashboard of the vehicle for adjusting tint of the vehicle. The control element 104 is preferably in the form of a control knob and can be turned to select a tint level of the windows and windshield. The control element 104 is coupled to the tinted glass 102 using a control circuitry 106. The circuitry 106 is adapted to transmit control signals from the adjustment knob 104 to the tinting glass 102.

Specifically, the tinting glass 102 includes an accompanied tint control module 108 which is adapted to control and adjust tinting of the glass 102 upon receiving control signals from the control element 104. Preferably, low-voltage control signals are received by the tinting module 108 to adjust the tint level based on user inputs using the control element 104. A light sensor 110 is included in the system 100 for detecting the intensity of sunlight and send data to the tinting control module 108 through a sensor wiring 112. The tinting control module 108 processes the information received from the sensor 110 and adjusts the tint level autonomously or automatically, thereby providing optimal comfort and UV protection.

In the preferred embodiment, the tinting control module 108 operates independently of the electronic control unit (ECU) of the vehicle and may interact with the ECU for specific functions or diagnostics such showing a malfunction in the system 100 on dashboard of the vehicle. In other embodiments, the tinting control module 108 can be integrated into ECU of the vehicle and may also adjust tint based on the speed of the vehicle.

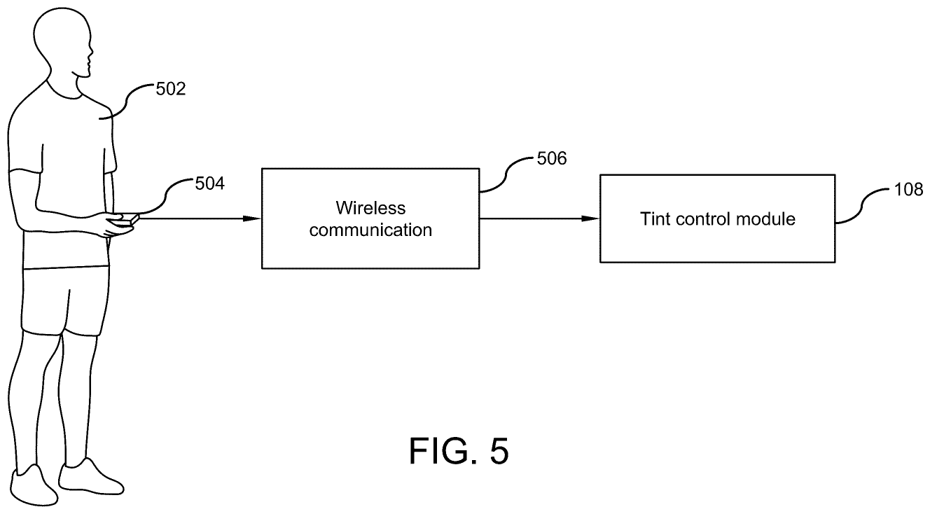

A mobile application 114 adapted to be installed in a handheld electronic computing device such as a mobile phone (FIG. 5) is also included in the system 100 to control the tint level of the tint glass 102 remotely, thereby offering convenience and additional functionality. A wireless instruction signal is received by the tinting control module 108 from the mobile application 114 and adjusts the tint level of the windows and windshield.

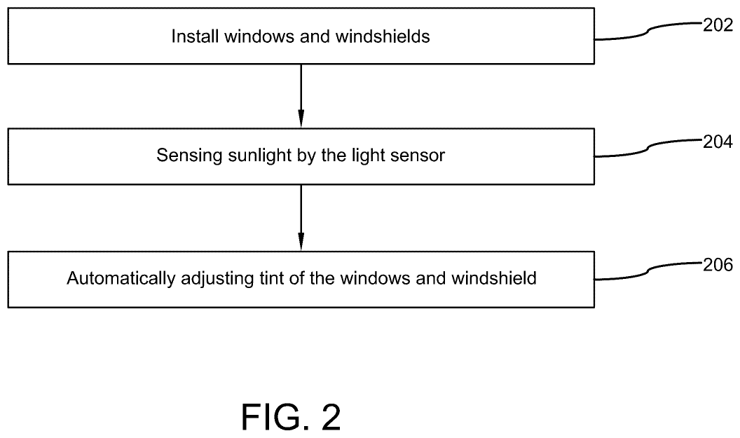

FIG. 2 illustrates a flow chart depicting a process of automatic tint adjustment of the windows and windshield using the windows tint adjustment system of the present invention in accordance with the disclosed structure. Initially, the tinted windows and windshields are installed in a vehicle and are connected to the tinting module 108 (Step 202). Then, the light sensor 110 included in the system 100 detects the sunlight and transmits a signal to the tinting module 108 (Step 204). The sensor 110 can be embedded in the window or can also be embodied as a separate unit.

Then, based on the level of sunlight, the tinting module 108 tints the windows and windshield to provide protection from the sunlight (Step 206). This provides continuous and adaptive protection against UV rays and glare without requiring user intervention. The tinting module 108 adjusts the tint of the individual windows and windshield in real-time and wherein the tint level of the individual windows and windshield can be different. In one embodiment, the automatic tint adjustment of the system 100 can be disabled using the mobile application 114.

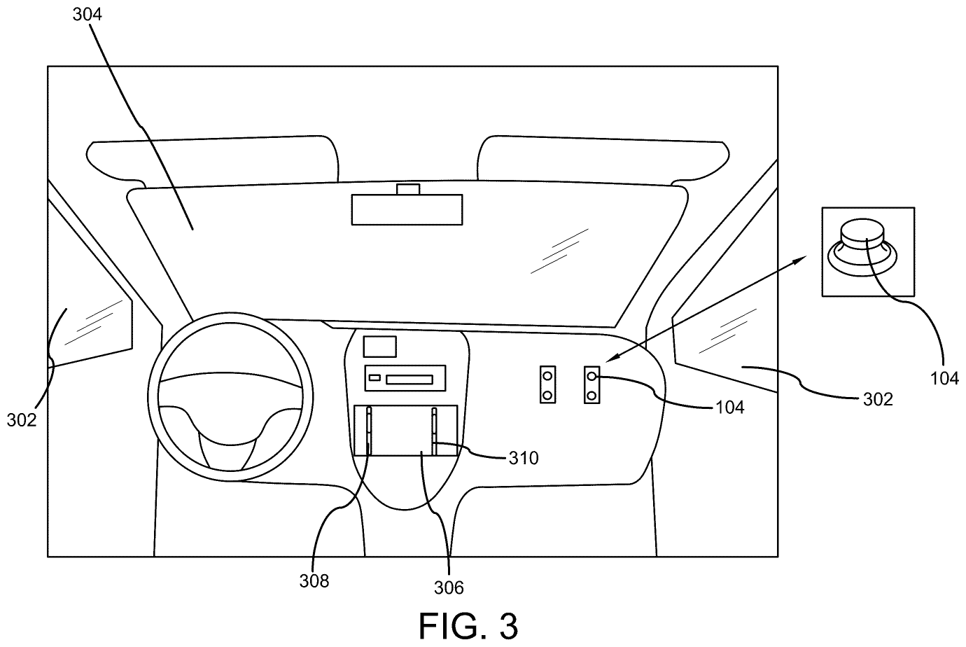

FIG. 3 illustrates a perspective view showing the control element disposed inside the vehicle for controlling tint of windows and windshield in accordance with the disclosed structure. As illustrated, the control element 104 is in the form of a knob which can be turned to adjust tint of the windows 302 and the windshield 304. The system 100 is configured to be compliant with the regulations for tinting of vehicles and prevent tint of the vehicles beyond an upper threshold of the tint level wherein the upper threshold can be preconfigured in the system 100.

The mobile application 114 can also be accessed using a display 306 which can be a touch surface. The display 306 displays the current tint level and enables a user to adjust the tint level of the windows 302 and the windshield 304 separately using the scroll bars 308, 310. The color of tint of the windows and windshield can be adjusted to various colors, enabling for customization according to user preference or to match the vehicle's aesthetics. The mobile application 114 can provided different types of interfaces for enabling a user to adjust tint level of the windows and the windshield.

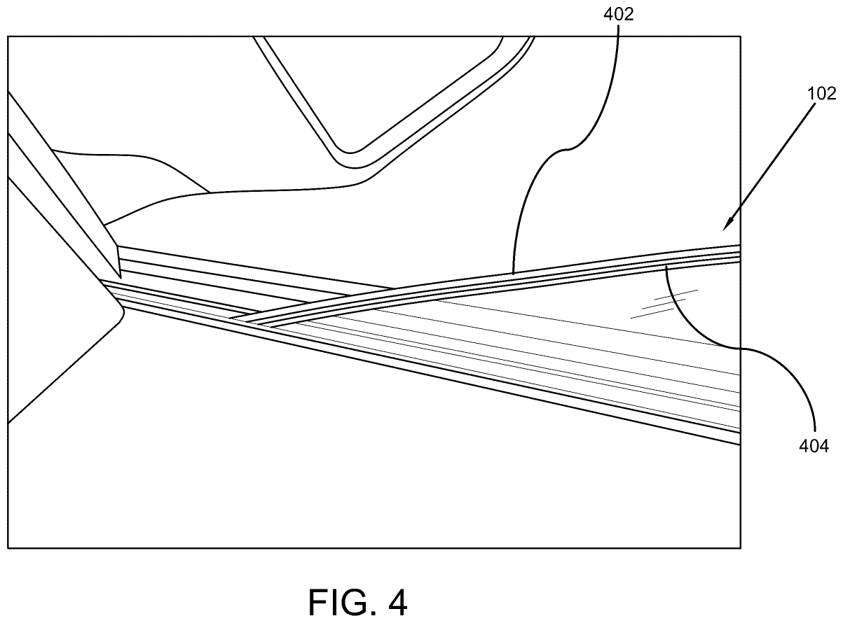

FIG. 4 illustrates a perspective view of the one embodiment of the dual tint glass used for making windows and windshield in accordance with the disclosed structure. In the present embodiment, the tint glass 400 includes an outer layer 402 which functions as a photochromic layer and is adapted to react to sunlight, darkening automatically when exposed to UV rays and lightening in the absence of sunlight. The inner layer 404 of the tint glass 400 is preferably an electrochromic layer and the tint thereof is controlled by manually via a knob, through a mobile app, or via touch screen settings within the vehicle. In windshields, a plastic layer such as a polyvinyl butyral layer can be added between the layers 402, 404 for providing additional support to the windshield.

FIG. 5 illustrates a perspective view showing a user using a mobile phone for remotely controlling tint of the windows and windshield in accordance with one embodiment of the present invention. As illustrated, the user 502 uses the mobile phone 504 which includes the mobile application 114 installed therein for coupling to the tint control module 108 installed inside the vehicle. The coupling is preferably done using a short-range wireless communication channel 506 but can also be done through long-range wireless channel. Wireless instruction signals are received by the module 108 from the application 114 for adjusting tint of the windows and windshield.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “adjustable vehicular window tinting system”, “windows and windshield tinting system”, “advanced window tinting system”, and “system” are interchangeable and refer to the vehicular windows and windshield adjustable tinting system 100 of the present invention.

Notwithstanding the forgoing, the vehicular windows and windshield adjustable tinting system 100 of the present invention can be of any suitable size and configuration as is known in the art without affecting the overall concept of the invention, provided that it accomplishes the above stated objectives. One of ordinary skill in the art will appreciate that the vehicular windows and windshield adjustable tinting system 100 as shown in the FIGS. are for illustrative purposes only, and that many other sizes and shapes of the vehicular windows and windshield adjustable tinting system 100 are well within the scope of the present disclosure. Although the dimensions of the vehicular windows and windshield adjustable tinting system 100 are important design parameters for user convenience, the vehicular windows and windshield adjustable tinting system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A window tinting system for vehicle glass comprising:
an adaptable tinted glass window;
a control element;
a control circuitry; and
a tint control module;
wherein said adaptable tinted glass window is a vehicle window;
wherein said adaptable tinted glass window having an adjustable tint level;
wherein said control element is coupled to said vehicle window;
wherein said control circuitry transmits control signals from said control element to said tint control module for selecting said adjustable tint level of said vehicle window; and
further wherein said control element disposed inside the vehicle for adjusting said adjustable tint level of said vehicle window.

2. The window tinting system for vehicle glass of claim 1, wherein said control element having a control knob for turning and selecting said adjustable tint level of said vehicle window.

3. The window tinting system for vehicle glass of claim 1, wherein said vehicle window is a vehicle windshield.

4. The window tinting system for vehicle glass of claim 1, wherein said adjustable tint level adjusted manually.

5. The window tinting system for vehicle glass of claim 4, wherein said adjustable tint level is adjusted based on user inputs.

6. The window tinting system for vehicle glass of claim 1 further comprising a light sensor and a sensor wire, wherein said light sensor detects intensity of sunlight and transmits said intensity to said tint control module through said sensor wire.

7. The window tinting system for vehicle glass of claim 6, wherein said adjustable tint level adjusted autonomously through said tint control module.

8. A window tinting system for vehicle glass comprising:
an adaptable tinted glass window;
a control element;
a control circuitry;
a tint control module;
a mobile application; and
a handheld electronic computing device;
wherein said adaptable tinted glass window is a vehicle window;
wherein said adaptable tinted glass window having an adjustable tint level;
wherein said control element is coupled to said vehicle window;
wherein said control circuitry transmits control signals from said control element to said tint control module for selecting said adjustable tint level of said vehicle window; and
further wherein said handheld electronic computing device having said mobile application for controlling said control element and said tint control module to select said adjustable tint level.

9. The window tinting system for vehicle glass of claim 8, wherein the controlling of said control element and said tint control module is wireless.

10. The window tinting system for vehicle glass of claim 8, wherein said vehicle window is a vehicle windshield.

11. The window tinting system for vehicle glass of claim 9, wherein said adjustable tint level adjusted remotely.

12. The window tinting system for vehicle glass of claim 8, wherein said adjustable tint level is adjusted based on user inputs.

13. The window tinting system for vehicle glass of claim 6, wherein said adjustable tint level adjusted autonomously through said tint control module.

14. A method of window tinting vehicle glass, the method comprising the steps of:
providing an adaptable tinted glass window, a control element, a control circuitry, a tint control module, and a light sensor, wherein said adaptable tinted glass window is a vehicle window, further wherein said adaptable tinted glass window having an adjustable tint level;
coupling said control element to said vehicle window;
transmitting control signals with said control circuitry from said control element to said tint control module; and
selecting said adjustable tint level of said vehicle window.

15. The method of window tinting vehicle glass of claim 14, wherein said control element disposed inside the vehicle for adjusting said adjustable tint level of said vehicle window, and further wherein said control element having a control knob for turning and selecting said adjustable tint level of said vehicle window.

16. The method of window tinting vehicle glass of claim 15, wherein said vehicle window is a vehicle windshield.

17. The method of window tinting vehicle glass of claim 15, wherein said adjustable tint level adjusted manually.

18. The method of window tinting vehicle glass of claim 17, wherein said adjustable tint level is adjusted based on user inputs.

19. The method of window tinting vehicle glass of claim 14 further comprising a step of providing a light sensor and a sensor wire, wherein said light sensor detects intensity of sunlight and transmits said intensity to said tint control module through said sensor wire.

20. The method of window tinting vehicle glass of claim 19, wherein said adjustable tint level adjusted autonomously through said tint control module.
